(19) United States
(12) Patent Application Publication
(10) Pub. No.: US 2014/0267014 A1
(43) Pub. Date: Sep. 18, 2014

(54) Delivery System

(71) Applicant: Ethel Williams, Macomb Township, MI (US)

(72) Inventor: Ethel Williams, Macomb Township, MI (US)

(21) Appl. No.: 13/841,362

(22) Filed: Mar. 15, 2013

(51) Int. Cl. B60Q 1/26; G06F 3/02

(52) U.S. Cl. CPC B60Q 1/26; G06F 3/02
USPC 345/156

(57) ABSTRACT

A message delivery system includes at least one display portion configured to deliver a predetermined message from a vehicle to other motorists and pedestrians. The message includes positive apologetic messages as well as reasonable requests that scroll in bright neon colored lights in real time and may be displayed so as to diffuse volatile situations and indicate anticipated maneuvers by the vehicle. The message delivery system includes an illuminated display portion, such as, a portable display and a mounted display, that prominently display from a vehicle. The portable display is configured to be gripped and extended from the vehicle for other motorists to view. A message may be entered in the portable display or a control portion, whereby the same message displays in the mounted display also. The control portion also serves to enter a message, which then relays to either, or both displays.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to delivering messages. More particularly, one or more embodiments of the invention relate to a system for delivering messages to motorists from a vehicle.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a sign is a representation of an object that implies a connection between itself and its object. A natural sign bears a causal relation to its object. A sign may include a message that conveys a point.

Typically, traffic signs are signs erected at the side of or above roads to provide information to road users. Traffic signs help direct traffic and minimize confusion on the roadway. Traffic signs can help minimize the stress associated with driving.

Typically, road rage and other driving frustrations can include aggressive or angry behavior by a driver of an automobile or other motor vehicle. Such behavior might include rude gestures, verbal insults, deliberately driving in an unsafe or threatening manner, or making threats. Road rage can lead to altercations, assaults, and collisions which result in injuries and even deaths. Road range can be thought of as an extreme case of aggressive driving.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary message display system, in accordance with an embodiment of the present invention;

FIG. 2 illustrates detailed perspective view of an exemplary control portion with an exemplary transmission line, in accordance with an embodiment of the present invention;

FIGS. 3A, 3B, 3C, and 3D illustrate views of an exemplary portable display and an exemplary predetermined message, in accordance with an embodiment of the present invention;

FIG. 4 illustrates a rear view of an exemplary mounted display, in accordance with an embodiment of the present invention; and

FIG. 5 illustrates a typical computer system that, when appropriately configured or designed, can serve as an exemplary method for identification, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of message delivery systems that may be provided by preferred embodiments of the present invention. In one embodiment of the present invention, the message delivery system may include at least one display portion configured to deliver a predetermined message from a vehicle to other motorists and pedestrians. The message may be written so as to diffuse volatile situations and indicate anticipated maneuvers by the vehicle. In some embodiments, the message delivery system may include an illuminated display portion, such as, a portable paddle and a message board, that prominently display from a vehicle. A predetermined message may be selected to display to other motorists so as to defuse volatile situations and road rage. In one embodiment, a customized message may also be entered in real time for display. The customized message may be generated by utilizing a universal serial bus interface. For example, without limitation, the messages may include positive apologetic messages as well as reasonable requests that scroll in bright neon colored lights in real time followed by a good will message: “May I Pass?”, “Thank You”, “Have a nice day”, “MAY I MERGE RIGHT”, “MAY I MERGE LEFT”, THANK YOU”, “I'M SORRY”, “HAVE A NICE DAY”, “HAPPY HOLIDAY”, “HAPPY NEW YEAR”, “CONGRATULATIONS”, etc. Specialty paddles can be customized for the occasion; “UNIVERSITY OF MICHIGAN”, “GO BLUE”. Or, in some embodiments the right or left arrows may flash with the request.

In one embodiment of the present invention, the message delivery system may include a control portion for enabling and transmitting the message. The control portion may be operable to store and select a predetermined message that transmits to a display portion. The control portion may further be operable to enter a customized message for transmission by utilizing a universal serial bus interface and joining with an external device. In some embodiments, the control portion may include, without limitation, a remote control, a wired transmitter, a keyboard, and a software application on a mobile phone. The control portion may be configured to be operable for a hand to grip and enter messages while driving. In some embodiments, the control portion may include a message input portion configured to enable entry of the message. The message input portion may include a keyboard having a plurality of buttons and a power switch. The message may be entered into the message input portion, and then transmitted to a processor for deciphering and further transmission. The processor may also function to store the predetermined messages. Other shapes, for the portable display may include, without limitation, square, round, rectangular and oblong all with a handheld handle. A control display may display the input message for review prior to transmission. In some embodiments, the control portion may comprise a control data connection. The control data connection may position onto the control portion, whereby a peripheral device or a transmission line from a remote terminal may mate with the control portion. The control data connection may include, without limitation, a USB port, an input/output port, a male port, a female port, a telephone plug, and a socket.

In one embodiment of the present invention, the message delivery system may include a portable display for displaying the message. The message may include, without limitation, a predetermined message configured to modify behavior on a roadway. The portable display may include a processor for storing the predetermined messages. The portable display may be operable to display the appropriate message from a vehicle, directing the message towards other motorists. The portable display may include a handle end for gripping and entering a desired message. In some embodiments, the portable display may be gripped and a message entered simultaneously. The handle end may include a portable input portion for entering the message. In this manner, messages may originate from either the control portion, or any of the display portions. In some embodiments, the portable input portion may include a plurality of buttons and switches operable to enter the message. In this manner, the portable display may be grasped by the handle end and positioned in front of a window while driving. The portable display may also be extended outside the vehicle for display to an adjacent motorist. In some embodiments, the handle may include a display data connection that allows a transmission line to mate with additional display portions and/or control portions for transferring the message. However, in other embodiments, the display data connection may position anywhere on the portable display.

The portable display may further include a broad end that joins with the handle end. The broad end may contain a portable output portion configured to display the message through a surface, such as a vehicle window. The broad end may provide a sufficiently sized surface area so that the message may be viewed by a motorist or pedestrian outside the vehicle. The portable output portion may present the message in visual or tactile form. In some embodiments, the portable output portion may include, without limitation, a light emitting diode screen, a liquid crystal display screen, a plasma screen, and a segment display. For example, without limitation, the message flashes or scrolls in bright colored neon lights when the appropriate button is depressed on the handle end of the portable display or personal wireless remote control portion. The message may correspond with the real time situation or conflict that arises while operating the vehicle. In some embodiments, the portable output portion may display the message received from the control portion.

In some embodiments, the message delivery system may include at least one mounted display for receiving and displaying the message. The at least one mounted display may be operatively connected to the portable display and the control portion, whereby each display may communicate with the other. The at least one mounted display may mount on a vehicle in such a manner as to be visible through the surface to other motorists and pedestrians. The at least one mounted display may include a mount for joining the at least one mounted display with an object. The object may include, without limitation, a rear window of a vehicle, a side window of a vehicle, a vehicle bumper, and a vehicle door. The at least one mounted display may further comprise at least one fastener for securing to a planar surface. The at least one fastener may include, without limitation, a sucker, an adhesive, a magnet, a clip, and a hook and loop fastener. Similar to the portable display, the at least one mounted display may include a mounted output portion for displaying the messages. The mounted output portion may include a light emitting diode screen, a liquid crystal display screen, a plasma screen, and a segment display. For example, without limitation, the message flashes or scrolls in bright colored neon lights across the mounted output portion in response to the message entered into the portable input portion, or the control portion. The message that displays on the mounted output portion may correspond with the message that displays on the output portion of the portable display. In some embodiments, the at least one mounted display may include a receiver for receiving an electric transmission from the control portion and/or the portable display. The receiver may be operable to transmit the electric transmission to the at least one mounted display, which transmits on to the processor for additional processing. The desired message may then display on the mounted output portion from the vehicle.

FIG. 1 illustrates a detailed perspective view of an exemplary message display system, in accordance with an embodiment of the present invention. In the present invention, a message delivery system 100 may include at least one display portion configured to deliver a message 102 from a vehicle to other motorists and pedestrians. The message may be written so as to diffuse volatile situations and indicate anticipated maneuvers by the vehicle. In some embodiments, the message delivery system may include an illuminated display portion, such as, a portable paddle and a message board, that prominently display from a vehicle. A predetermined message may be selected to display to other motorists so as to defuse volatile situations and road rage. In one embodiment, a customized message may also be entered in real time for display. The customized message may be generated by utilizing a universal serial bus interface with a remote control. In some embodiments, the messages may include positive apologetic conveyences as well as reasonable requests that scroll in bright neon colored lights in real time followed by a good will message: “May I Pass?”, “Thank You”, “Have a nice day”.

For example, without limitation, a driver may open up a drivers side window to extend a display paddle out to engage an adjacent driver. The driver may utilize the left hand to extend the paddle outward and to display the appropriate message in bright neon lights. Single motion activation buttons on the handle end of the paddle display can be depressed with a finger or a thumb. If the message had a positive outcome and the request was obliged and/or accepted, then the engaged driver may flash a THANK YOU button, followed by, HAVE A NICE DAY button with a smiling face. The messages display on the paddle display and a rear mounted display. The rear mounted display may use suction cups, or a permanent unit in the new car market installed by the auto manufacturers. In some embodiments, the mounted display mounts to a rear bumper or trunk mount, and can be attached with magnets or screws.

In one embodiment of the present invention, the message delivery system may include a control portion 104 for enabling and transmitting the message. The control portion may be operable to store and select a predetermined message that transmits to a display portion. In some embodiments, the wireless remote may be capable of being used from a few feet of the base. The control portion may further be operable to allow entry of a customized message for transmission by utilizing a universal serial bus interface and joining with an external device. In some embodiments, the control portion may include, without limitation, a remote control, a wired transmitter, a keyboard, and a software application on a mobile phone. The control portion may be configured to be operable for a hand to grip and enter messages while driving. In some embodiments, the control portion may include a message input portion 106 configured to enable entry of the message. The message input portion may include a keyboard having a plurality of buttons and a power switch. However, in an alternative embodiment, the message input portion may include voice recognition software for entering messages from a user's voice. In some embodiments, the message may be entered into the message input portion, and then transmitted to a processor for deciphering and further transmission. The processor may also function to store the predetermined messages. In one embodiment, a control display 108 may display the input message for review prior to transmission. In some embodiments, the control portion may comprise a control data connection 110. The control data connection may position onto the control portion, whereby a peripheral device or a transmission line 112 from a remote terminal may mate with the control portion. The control data connection may include, without limitation, a USB port, an input/output port, a male port, a female port, a telephone plug, and a socket. The control portion may receive power from a power source, including, without limitation, a rechargeable battery, a nickel-cadmium battery, USB port, cigarette lighter outlet, and a solar power source.

In one embodiment of the present invention, the message delivery system may include a portable display 114 for displaying the message. The message may include, without limitation, a predetermined message configured to modify behavior on a roadway. The portable display may include a processor for storing the predetermined messages. The portable display may be operable to display the appropriate message from a vehicle, directing the message towards other motorists. The portable display may include a handle end 116 for gripping and entering a desired message. In some embodiments, the portable display may be gripped and a message entered simultaneously. The handle end may include a finger grip bed configured to be operable to comfortably grip. The handle end may include a portable input portion 118 for entering the message. The portable input portion may include a plurality of buttons. Each button may include a predetermined message, whereby depressing a button may display the respective message. In this manner, the message may originate from either the control portion, or any of the display portions. In this manner, the portable display may be grasped by the handle end and positioned in front of a window while driving. The portable display may also be extended outside the vehicle for display to an adjacent motorist. In some embodiments, the handle end may include a display data connection 120 that allows a transmission line to mate with additional display portions and/or control portions for transferring the message. However, in other embodiments, the display data connection may position anywhere on the portable display. The portable display may receive power from a power source, including, without limitation, a rechargeable battery, a nickel-cadmium battery, and a solar power source.

The portable display may further include a broad end 122 that joins with the handle end. The broad end may contain a portable output portion 124 configured to display the message through a surface, such as a vehicle window. The broad end may provide a sufficiently sized surface area so that the message may be viewed by a motorist or pedestrian outside the vehicle. The portable output portion may present the message in visual or tactile form. In some embodiments, the portable output portion may include, without limitation, a light emitting diode screen, a liquid crystal display screen, a plasma screen, and a segment display. For example, without limitation, the message flashes or scrolls in bright colored neon lights when the appropriate button is depressed on the handle end of the portable display or personal wireless remote control portion. The message may correspond with the real time situation or conflict that arises while operating the vehicle. In some embodiments, the portable output portion may display the message received from the control portion. To help provide sufficient visibility while driving, in some practical embodiments, the broad end may be as wide as, without limitation, 9″×7″ or 9″×9″ or rectangular rear window scroll, 16″×5″ circular comparable to the above measurements.

In some embodiments, the message delivery system may include at least one mounted display 126 for receiving and displaying the message. The at least one mounted display may be operatively connected to the portable display and the control portion, whereby each component may communicate with the other. The at least one mounted display may mount on a vehicle in such a manner as to be visible through the surface to other motorists and pedestrians. Suitable messages for the at least one mounted display may include, without limitation, MAY I RIGHT MERGE, MAY I LEFT MERGE, THANK YOU, I'M SORRY, and HAVE A NICE DAY with a smiling face.

In some embodiments, the at least one mounted display may include a mount 128 for joining the at least one mounted display with an object. The object may include, without limitation, a rear window of a vehicle, a side window of a vehicle, a vehicle bumper, and a vehicle door. The at least one mounted display may further comprise at least one fastener 130 for securing to a planar surface. The at least one fastener may include, without limitation, a sucker, an adhesive, a magnet, a clip, and a hook and loop fastener. Similar to the portable display, the at least one mounted display may include a mounted output portion 132 for displaying the message. The mounted output portion may include a light emitting diode screen, a liquid crystal display screen, a plasma screen, and a segment display. The at least one mounted display may include a rectangular shape, sized and dimensioned to extend across a rear portion of a vehicle. For example, without limitation, the message flashes or scrolls in bright colored neon lights across the mounted output portion in response to the message entered into the portable input portion, or the control portion. The message that displays on the mounted output portion may correspond with the message that displays on the output portion of the portable display. In some embodiments, the at least one mounted display may include a receiver for receiving an electric transmission from the control portion and/or the portable display. The receiver may be operable to transmit the electric transmission to the at least one mounted display, which transmits on to the processor for additional processing. The desired message may then display on the mounted output portion from the vehicle.

FIG. 2 illustrates detailed perspective view of an exemplary control portion with an exemplary transmission line, in accordance with an embodiment of the present invention. In the present invention, the message delivery system may include a control portion for enabling and transmitting the message. The control portion may be operable to store and select a predetermined message that transmits to a display portion. The control portion may further be operable to allow entry of a customized message for transmission by utilizing a universal serial bus interface and joining with an external device. In some embodiments, the control portion may include, without limitation, a remote control, a wired transmitter, a keyboard, and a software application on a mobile phone. The control portion may be configured to be operable for a hand to grip and enter messages while driving. In some embodiments, the control portion may include a message input portion configured to enable entry of the message. The message input portion may include a keyboard having a plurality of buttons and a power switch. However, in an alternative embodiment, the message input portion may include voice recognition software for entering messages from a user's voice. In some embodiments, the message may be entered into the message input portion, and then transmitted to a processor for deciphering and further transmission. The processor may also function to store the predetermined messages. In one embodiment, a control display may display the input message for review prior to transmission. In some embodiments, the control portion may comprise a control data connection. The control data connection may position onto the control portion, whereby a peripheral device or a transmission line from a remote terminal may mate with the control portion. The control data connection may include, without limitation, a USB port, an input/output port, a male port, a female port, a telephone plug, and a socket.

FIGS. 3A, 3B, 3C, and 3D illustrate views of an exemplary portable display and an exemplary predetermined message, in accordance with an embodiment of the present invention. In the present invention, the message may be written so as to diffuse volatile situations and indicate anticipated maneuvers by the vehicle. Those skilled in the art, in light of the present invention, will recognize that road rage is an aggressive or angry behavior by a driver of a vehicle in response to a misunderstanding or self-perceived injustice. The message delivery system may provide a friendly message, worded to diffuse the frustrations of commuters, thereby helping to reduce road rage. In some embodiments, the message delivery system may include an illuminated display portion, such as, a portable paddle and a message board, that prominently display from a vehicle. In one alternative embodiment, the message may include a scrolling and/or flashing light emitting diode in conjunction with audio signals. In one embodiment, a predetermined message may be selected to display to other motorists so as to defuse volatile situations and road rage. In one embodiment, a customized message may also be entered in real time for display. The customized message may be generated by utilizing a universal serial bus interface with a remote control. In some embodiments, the messages may include positive apologetic conveyences as well as reasonable requests that scroll in bright neon colored lights in real time followed by a good will message: “May I Pass?”, “Thank You”, “Have a nice day”. In one alternative embodiment, the message may include a language other than English.

FIG. 4 illustrates a rear view of an exemplary at least one mounted display, in accordance with an embodiment of the present invention. In the present invention, the at least one mounted display may include a receiver 402 for receiving an electric transmission from the control portion and/or the portable display. The receiver may be operable to transmit the electric transmission to the at least one mounted display, which transmits on to the processor for additional processing. The desired message may then display on the mounted output portion from the vehicle. In yet another embodiment, a transmission line may join the at least one mounted display with the portable display, whereby the message enabled by the portable input portion transmits and displays on the mounted output portion. In yet another embodiment, the message may remotely transmit from the control portion to the receiver to transmit the message generated by the message input portion. In yet another embodiment, the control portion may enable a customized message with a universal serial bus interface and a preselected button on the portable input portion. In this manner, a keyboard may include a plurality of alphanumeric characters for typing in the customized message. Other suitable locations for mounting, include, without limitation, on windows, bumpers, and trunk. In the present embodiment, the input key board will be able to upload words and phrases that screened from being non threatening, free from obscenity and non-inflammatory messages. In the present embodiment, the universal serial bus interface will allow for customizing within specified guide lines and pre-selected vocabulary list. In the present embodiment, words that trigger hostility, anger and rage are filtered out.

In one alternative embodiment, the message delivery system may be utilized beyond the vehicle, including, without limitation, special occasions, weddings, graduations, conventions, universities, private parties, and sports events. In yet another alternative embodiment, the message may display as a hologram, emitting from a source inside a vehicle. In yet another alternative embodiment, the portable display may be configured to receive a message from a law enforcement official, including, without limitation, “SLOW DOWN, PULL OVER”, and “EMERGENCY AHEAD”.

In one alternative embodiment, the present embodiment is further equipped with a video and/or camera, which audio/visual signals may be utilized and shared through the usb interface, and may be further shared via world wide web.

FIG. 5 illustrates a typical computer system that, when appropriately configured or designed, can serve as an exemplary method for identification, in accordance with an embodiment of the present invention. In the present invention, a communication system 500 includes a multiplicity of clients with a sampling of clients denoted as a client 502 and a client 504, a multiplicity of local networks with a sampling of networks denoted as a local network 506 and a local network 508, a global network 510 and a multiplicity of servers with a sampling of servers denoted as a server 512 and a server 514.

Client 502 may communicate bi-directionally with local network 506 via a communication channel 516. Client 504 may communicate bi-directionally with local network 508 via a communication channel 518. Local network 506 may communicate bi-directionally with global network 510 via a communication channel 520. Local network 508 may communicate bi-directionally with global network 510 via a communication channel 522. Global network 510 may communicate bi-directionally with server 512 and server 514 via a communication channel 524. Server 512 and server 514 may communicate bi-directionally with each other via communication channel 524. Furthermore, clients 502, 504, local networks 506, 508, global network 510 and servers 512, 514 may each communicate bi-directionally with each other.

In one embodiment, global network 510 may operate as the Internet. It will be understood by those skilled in the art that communication system 500 may take many different forms. Non-limiting examples of forms for communication system 500 include local area networks (LANs), wide area networks (WANs), wired telephone networks, wireless networks, or any other network supporting data communication between respective entities.

Clients 502 and 504 may take many different forms. Non-limiting examples of clients 502 and 504 include personal computers, personal digital assistants (PDAs), cellular phones and smartphones.

Client 502 includes a CPU 526, a pointing device 528, a keyboard 530, a microphone 532, a printer 534, a memory 536, a mass memory storage 538, a GUI 540, a video camera 542, an input/output interface 544 and a network interface 546.

CPU 526, pointing device 528, keyboard 530, microphone 532, printer 534, memory 536, mass memory storage 538, GUI 540, video camera 542, input/output interface 544 and network interface 546 may communicate in a unidirectional manner or a bi-directional manner with each other via a communication channel 548. Communication channel 548 may be configured as a single communication channel or a multiplicity of communication channels.

CPU 526 may be comprised of a single processor or multiple processors. CPU 526 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 536 is used typically to transfer data and instructions to CPU 526 in a bi-directional manner. Memory 536, as discussed previously, may include any suitable computer-readable media, intended for data storage, such as those described above excluding any wired or wireless transmissions unless specifically noted. Mass memory storage 538 may also be coupled bi-directionally to CPU 526 and provides additional data storage capacity and may include any of the computer-readable media described above. Mass memory storage 538 may be used to store programs, data and the like and is typically a secondary storage medium such as a hard disk. It will be appreciated that the information retained within mass memory storage 538, may, in appropriate cases, be incorporated in standard fashion as part of memory 536 as virtual memory.

CPU 526 may be coupled to GUI 540. GUI 540 enables a user to view the operation of computer operating system and software. CPU 526 may be coupled to pointing device 528. Non-limiting examples of pointing device 528 include computer mouse, trackball and touchpad. Pointing device 528 enables a user with the capability to maneuver a computer cursor about the viewing area of GUI 540 and select areas or features in the viewing area of GUI 540. CPU 526 may be coupled to keyboard 530. Keyboard 530 enables a user with the capability to input alphanumeric textual information to CPU 526. CPU 526 may be coupled to microphone 532. Microphone 532 enables audio produced by a user to be recorded, processed and communicated by CPU 526. CPU 526 may be connected to printer 534. Printer 534 enables a user with the capability to print information to a sheet of paper. CPU 526 may be connected to video camera 542. Video camera 542 enables video produced or captured by user to be recorded, processed and communicated by CPU 526.

CPU 526 may also be coupled to input/output interface 544 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 526 optionally may be coupled to network interface 546 which enables communication with an external device such as a database or a computer or telecommunications or internet network using an external connection shown generally as communication channel 516, which may be implemented as a hardwired or wireless communications link using suitable conventional technologies. With such a connection, CPU 526 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a message display system that relays messages from a vehicle to diffuse potential motorist misunderstandings according to the present invention will be apparent to those skilled in the art. Various aspects of the invention have been described above by way of illustration, and the specific embodiments disclosed are not intended to limit the invention to the particular forms disclosed. The particular implementation of the message display system that relays messages from a vehicle to diffuse potential motorist misunderstandings may vary depending upon the particular context or application. By way of example, and not limitation, the message display system that relays messages from a vehicle to diffuse potential motorist misunderstandings described in the foregoing were principally directed to a message entry control that transmits messages to displays positioned on a vehicle implementations; however, similar techniques may instead be applied to any situation where messages must be transmitted in high speed or high stress circumstances, such as a battlefield or a racetrack, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
a portable display, the portable display being configured to at least partially store and/or display a message, the portable display comprising a handle end, the handle end comprising a portable input portion, the portable input portion being configured to at least partially enable the message, the display portion further comprising a broad end, the broad end comprising a portable output portion, the portable output portion being operable to display the message, the portable display further being configured to be operable to grasp the handle end for orienting the broad end to display the message through a surface;
at least one mounted display, the at least one mounted display being configured to at least partially mount an object, the at least one mounted display comprising a mounted output portion, the mounted output portion being configured to display the message through the surface while mounted on the object, the at least one mounted display being operable to receive the message at least partially from the portable display; and
a control portion, the control portion comprising a message input portion, the message input portion being configured to at least partially enable the message, the control portion being configured to at least partially transmit the message to the portable display and/or the at least one mounted display.

2. The system of claim 1, in which the message comprises a predetermined message and/or a customized message, the customized message being at least partially enabled with a universal serial bus interface and/or at least one button on the portable input portion.

3. The system of claim 1, in which the message at least partially comprises a flashing neon light.

4. The system of claim 1, wherein the message is configured to at least partially modify behavior.

5. The system of claim 1, wherein the portable output portion and the mounted output portion display the message in conjunction.

6. The system of claim 1, in which the system comprises a transmission line, the transmission line being configured to join the portable display and/or the at least one mounted display and/or the control portion, the transmission line further being configured to transmit the message.

7. The system of claim 1, in which the portable display comprises a paddle.

8. The system of claim 1, wherein the portable display is configured to at least partially receive power from a battery, a USB port, or a cigarette lighter outlet.

9. The system of claim 1, in which the portable input portion comprises a plurality of buttons, the plurality of buttons being configured to at least partially enable entry of the message.

10. The system of claim 1, in which the handle end comprises a display data connection, the display data connection comprising a universal serial bus.

11. The system of claim 1, in which the portable output portion comprises a liquid crystal display screen.

12. The system of claim 1, in which the at least one mounted display comprises a receiver.

13. The system of claim 1, wherein the receiver is operable to receive and transmit the message.

14. The system of claim 1, in which the at least one mounted display comprises a mount for mounting to an object, the object comprising a rear portion of a vehicle.

15. The system of claim 1, in which the at least one mounted display comprises at least one fastener for mounting to a surface, the surface comprising a vehicle window.

16. The system of claim 1, in which the control portion comprises a remote control.

17. The system of claim 1, in which the control portion comprises a control display, the control display being configured to display the message,

18. The system of claim 1, in which the control portion comprises a control data connection, the control data connection being configured to at least partially enable a customized message, the control data connection comprising a universal serial bus.

19. A system comprising:
means for positioning a portable display in a vehicle to be viewed through a surface;
means for mounting at least one mounted display on an object of the vehicle to be viewed through the surface;
means for joining the portable display with the at least one mounted display;
means for enabling a message from a control portion;
means for transmitting the message to the portable display and/or the at least one mounted display;
means for enabling the message from a portable input portion; and
means for displaying the message on a portable output portion and/or a mounted output portion.

20. A system consisting of:
a portable display, the portable display being configured to at least partially store and/or display a message, the message comprising a predetermined message and/or a customized message, the customized message being at least partially enabled with a universal serial bus interface and a sixth button on the portable input portion, the message further at least partially comprising a flashing neon light, message further being configured to at least partially modify behavior, the portable display comprising a paddle, the portable display being configured to at least partially receive power from a battery, the portable display further comprising a handle end, the handle end comprising a portable input portion, the portable input portion being configured to at least partially enable the message, the handle end further comprising a display data connection, the display data connection comprising a universal serial bus, the display portion further comprising a broad end, the broad end comprising a portable output portion, the portable output portion being operable to display the message, the portable display further being configured to be operable to grasp the handle end for orienting the broad end to display the message through a surface, the surface comprising a vehicle window;
at least one mounted display, the at least one mounted display being configured to at least partially mount an object, the object comprising a rear portion of a vehicle, the at least one mounted display comprising a mounted output portion, the mounted output portion being configured to display the message through the surface while mounted on the object, the at least one mounted display being operable to receive the message at least partially from the portable display, the at least one mounted display further comprising a receiver, the receiver being operable to receive and transmit the message, the at least one mounted display further comprising a mount, the at least one mounted display further comprising at least one fastener; and
a control portion, the control portion comprising a message input portion, the message input portion being configured to at least partially enable the message, the control portion further comprising a control display, the control portion further comprising a control data connection, the control data connection being configured to at least partially enable a customized message, the control portion being configured to at least partially transmit the message to the portable display and/or the at least one mounted display.
